(19) United States
(12) Patent Application Publication
(10) Pub. No.: US 2009/0086238 A1
(43) Pub. Date: Apr. 2, 2009

(54) Methods for Determining Document Characteristics from PDL Data

(76) Inventor: Mabry Dozier, Lafayette, CO (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/864,812

(22) Filed: Sep. 28, 2007

(51) Int. Cl. G06K 15/00; G06F 3/12

(52) U.S. Cl. 358/1.13

(57) ABSTRACT

Methods and computer-readable media containing instructions for controlling computer systems consistent with embodiments of the present invention provide for a method for determining document characteristics from page description language (“PDL”) data. In some methods for determining document characteristics from PDL data, the PDL data is translated into final printable data. Document characteristics may be extracted and stored using information obtained during the translation of the PDL data into final printable data. Extracted document characteristics may be displayed in a graphical format, allowing users to make accurate estimates of the resources needed for print jobs.

### FIELD OF THE INVENTION

The present invention relates to the field of printing and, in particular, to systems and methods for determining document characteristics from page description language data.

### DESCRIPTION OF RELATED ART

Documents are often stored in electronic format for archival purposes. The pages of an electronically stored document are commonly described using a page description language (“PDL”) that provides a high-level description of each page in the document. This high-level description may be transformed into final printable data before printing. Final printable data may then be used to print the document.

Users would often like to determine document characteristics prior to printing a document. For example, a user may wish to determine the required paper size, page resolution, page orientation, and toner/ink requirements of a document. Such information can allow a user to allocate printer resources prior to printing a large document. For example, users may be able to ensure the availability of an adequate amount of paper of appropriate sizes and/or toner/ink prior to printing a document.

Many document characteristics cannot be determined directly from PDL data. Typically, users will print a document in its entirety in order to determine various document characteristics. This process wastes printing resources, and is time inefficient. Moreover, without a prior knowledge of the resources needed to complete a print job, there is no guarantee that the print job will not stall. Thus, there is a need for methods to determine document characteristics using PDL data to allow users to make accurate estimates of the resources needed for print jobs.

### SUMMARY

In accordance with the present invention methods for determining document characteristics from PDL data are presented.

In some embodiments, a method for determining document characteristics from a file containing PDL data comprises determining the type of PDL data contained in the file, translating the PDL data for the PDL data type into a final printable data, extracting document characteristics using information obtained during the translation of the PDL data into the final printable data, and storing the extracted document characteristics. In some embodiments, the method further comprises displaying the document characteristics in a graphical format.

Extracted document characteristics may include PDL file type information, number of pages in a document, size of a document, resolution of a document, orientation of a document, color output of a document, bit depth of pages in a document, paper type of pages in a document, and toning material requirements.

These and other embodiments are further explained below with respect to the following figures.

### BRIEF DESCRIPTION OF THE DRAWINGS

FIG. 1 shows an exemplary system illustrating components for printing documents.

FIG. 2 shows a block diagram of an exemplary printer.

FIG. 3 shows a high-level process flow diagram illustrating steps in a method for determining document characteristics from PDL data.

FIG. 4 shows an exemplary flowchart illustrating steps in a method for determining document characteristics when PDL data is being translated into lower-level printer data.

FIG. 5 shows an exemplary flowchart illustrating steps in a method for determining document characteristics when lower-level printer data is being translated into final printable data.

FIG. 6 shows an exemplary format for displaying document characteristics.

### DETAILED DESCRIPTION

Reference will now be made in detail to one or more exemplary embodiments of the present invention as illustrated in the accompanying drawings. Wherever possible, the same reference numbers will be used throughout the drawings to refer to the same or like parts.

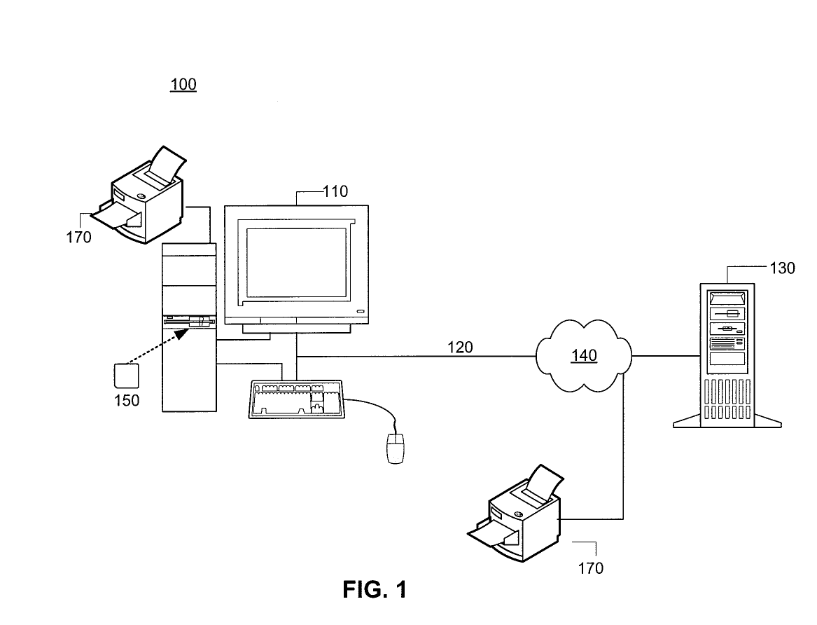

FIG. 1 shows a block diagram 100 illustrating components in an exemplary system for printing documents. An application for dynamic configuration and management of printers may be deployed on a network of computers and printing devices, as shown in FIG. 1 that are connected through communication links, which allow information to be exchanged using conventional communication protocols and/or data port interfaces.

As shown in FIG. 1, exemplary system 100 includes computers such as exemplary computing device 110 and server 130. Further, computing device 110 and server 130 communicates over a connection 120, which passes through network 140. Computing device 110 can be a computer workstation, desktop computer, laptop computer, or any other computing device capable of being used in a networked environment. Server 130 is a platform capable of connecting to computing device 110 and other devices (not shown), for instance. Computing device 110 and server 130 are capable of executing software (not shown) that allows document processing and the printing of documents using printers 170.

Document processing software running on computing device 110 and/or server 130 allows users to view, edit, process, and store documents conveniently. Pages to print in a document may be described in a PDL. PDL's may include PostScript, Adobe PDF, HP PCL, XL, TIFF, JPEG, XPS, and variants thereof. A PDL description of a document provides a high-level description of each page in a document. This PDL description is often translated to a series of lower-level printer-specific commands when the document is being printed. The translation process from PDL to lower-level printer-specific commands is usually complex and depend on the features and capabilities offered by exemplary printer 170.

In some embodiments, PDL commands are parsed by computer 110 and/or server 130 and high-level PDL instructions are broken down into a set of lower level instructions called primitives. When these primitives are fed to exemplary printer 170, they can be used to determine where to place marks on a page. In some instances, each primitive may be processed as it is generated. In other systems, a large set of primitives may be generated, stored, and then processed. For example, the primitives needed to describe a single page may be generated, stored in a list, and then processed. A set of stored primitives is often termed a display list.

Exemplary printer 170 includes devices that produce physical documents from electronic data including, but not limited to, laser printers, ink-jet printers, LED printers, and plotters. Needless to say, facsimile machines and digital copiers can be regarded as printers. Exemplary printer 170 may also be capable of directly printing documents received from computing device 110 or server 130 over connection 120. In some embodiments such an arrangement allows for the direct printing of documents, with (or without) additional processing by computing device 110 or server 130. The processing of documents, which typically contains one or more of text, graphics, and images, can be distributed. Thus, computing device 110 and/or server 130 may perform portions of document print processing such as the extraction of document characteristics from PDL data, half-toning, color matching, and/or other manipulation processes before a document is physically printed by printer 170.

Computing device 110 also contains removable media drive 150. Removable media drive 150 may include, for example, 3.5 inch floppy drives, CD-ROM drives, DVD ROM drives, CD±RW or DVD±RW drives, USB flash drives, and/or any other removable media drives. Portions of applications may reside on removable media and be read by computing device 110 using removable media drive 150 prior to being acted upon by system 100.

Connection 120 couples computing device 110, server 130, and printer 170 and may be implemented as a wired or wireless connection using conventional communication protocols and/or data port interfaces. In general, connection 120 can be any communication channel that allows transmission of data between the devices. In one embodiment, for example, the devices may be provided with conventional data ports, such as parallel ports, serial ports, Ethernet, USB, SCSI, FIREWIRE, and/or coaxial cable ports for transmission of data through the appropriate connection.

Network 140 could include a Local Area Network (LAN), a Wide Area Network (WAN), or the Internet. In some embodiments, information sent over network 140 may be encrypted to ensure the security of the data being transmitted. Printer 170 may be coupled to network 140 through connection 120. Exemplary printer 170 may also be connected directly to computing device 110 and/or server 130. System 100 may also include other peripheral devices (not shown). An application for extracting document characteristics from PDL data may be deployed on one or more of the exemplary computers or printers, as shown in FIG. 1. For example, computing device 110 could download and run portions of software from server 130. In some embodiments, an application for dynamic printer configuration and management may be executed entirely by printer 170 using some combination of hardware, software, and firmware.

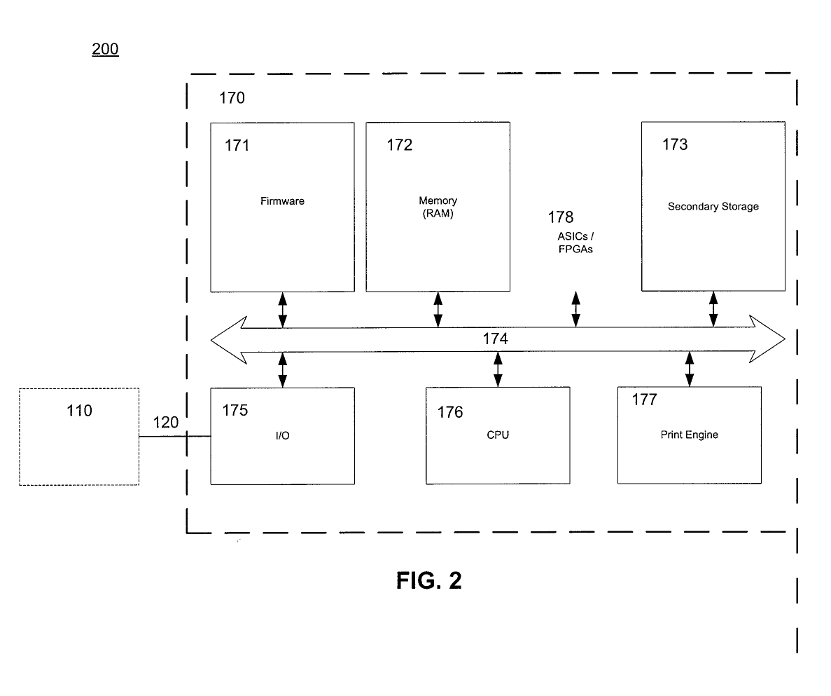

FIG. 2 shows a block diagram 200 of exemplary printer 170. Exemplary printer 170 contains bus 174 that couples CPU 176, firmware 171, memory 172, input-output ports 175, print engine 177, and secondary storage device 173. Exemplary Printer 170 may also contain other Application Specific Integrated Circuits (ASICs), and/or Field Programmable Gate Arrays (FPGAs) 178 that are capable of executing portions of an application to print or process documents. Exemplary printer 170 is also able to access secondary storage or other memory in computing device 110 using I/O ports 175 and connection 120. In some embodiments, printer 170 may also be capable of executing software including a printer operating system and other appropriate application software. Exemplary printer 170 allows paper sizes, output trays, color selections, print modes such as single-sided and duplex mode, and print resolution, among other options, to be user-configurable.

Exemplary CPU 176 may be a general-purpose processor, a special purpose processor, or an embedded processor. CPU 176 can exchange data including control information and instructions with memory 172 and/or firmware 171. Memory 172 may be any type of Dynamic Random Access Memory (“DRAM”) such as but not limited to SDRAM, or RDRAM. Firmware 171 may hold instructions and data including but not limited to a boot-up sequence, pre-defined routines including routines for image processing, routines for dynamic printer configuration and management, trapping, document processing, and other code. In some embodiments, code and data in firmware 171 may be copied to memory 172 prior to being acted upon by CPU 176. Routines in firmware 171 may include code to translate page descriptions received from computing device 110 to display lists. In some embodiments, firmware 171 may include rasterization routines to convert display commands in a display list to an appropriate rasterized bit map and store the bit map in memory 172. Firmware 171 may also include routines to scan and process bitmaps stored in memory such as a frame buffer, routines for image compression and decompression, and/or memory management routines. Data and instructions in firmware 171 may be upgradable using one or more of computer 110, network 140, removable media coupled to printer 170, and/or secondary storage 173.

Exemplary CPU 176 acts upon instructions and data and provide control and data to ASICs/FPGAs 178 and print engine 177 to generate printed documents. ASICs/FPGAs 178 may also provide control and data to print engine 177. FPGAs/ASICs 178 may also implement one or more of translation, trapping, bitmap scanning and processing, compression, and rasterization algorithms.

Exemplary computing device 110 transforms document data into a first printable data. In one embodiment, the first printable data may correspond to a PDL description of a document. Then, the first printable data can be sent to printer 170 for transformation into lower-level printer data. In some embodiments, the translation process from a PDL description of a document to the final printable data comprising of a series of lower-level printer-specific commands may include the generation of lower-level printer data comprising of display lists of objects. Display lists may hold one or more of text, graphics, and image data objects and one or more types of data objects in a display list may correspond to an object in a user document. Display lists, which may aid in the generation of lower-level printer data, may be stored in memory 172 or secondary storage 173.

Exemplary secondary storage 173 is an internal or external hard disk, memory stick, or any other memory storage device capable of being used by system 200. In some embodiments, the display list may reside and be transferred between one or more of printer 170, computing device 110, and server 130 depending on where the document processing occurs. Memory to store display lists may be a dedicated memory or form part of general purpose memory, or some combination thereof. In some embodiments, memory to hold display lists may be dynamically allocated, managed, and released as needed. Printer 170 transforms lower-level printer data into a final form of printable data and print according to this final form.

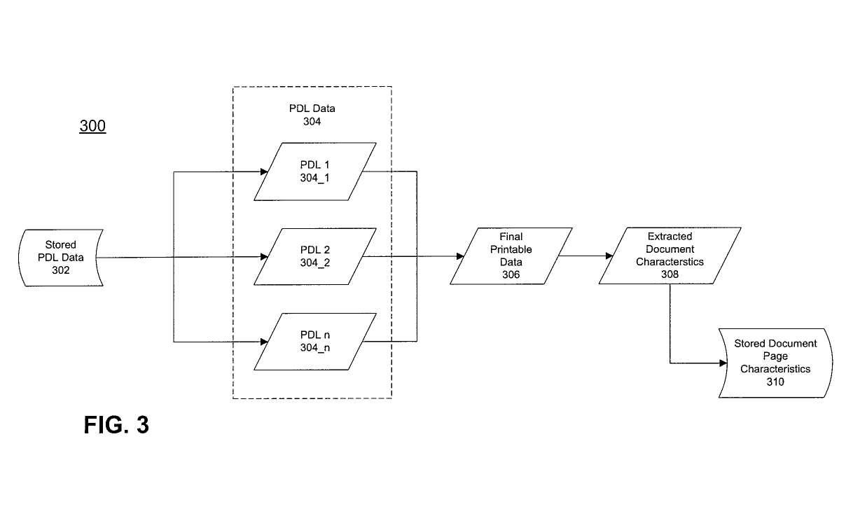

FIG. 3 shows an exemplary flowchart 300 illustrating steps in a method for determining document characteristics from PDL data. In some embodiments, PDL data 304 may be obtained from various files including one or more PDL file types stored in storage medium 302. Storage medium 302 may comprise an internal or external hard disk, memory stick, magnetic storage device, optical storage device, network storage device, or any other memory storage device capable of being used by printer 170 or computing device 110. In one embodiment, header information contained in PDL data files 304_1-304_n may be used to determine the type of PDL data (or PDL data type) contained in files 301 and an appropriate PDL interpreter module 460 corresponding to the PDL data type may be invoked. Some document characteristics 308 may be extracted directly by analyzing PDL data 304. In some embodiments, a PDL interpreter module may break down the high-level PDL data 304 for each page into lower-level printer data suitable for analysis of document characteristics 308. In one embodiment, lower-level printer data may be described by low-level instructions called primitives. In some embodiments, primitives corresponding to various objects may be stored in a display list. In some embodiments, PDL interpreter modules may be integrated as part of a larger PDL interpreter package.

In some embodiments, lower-level printer data may be transformed into a final form of printable data 306. For example, final printable data 306 may be described by bitmap data. This process may be called rasterization. During the process of translating PDL data 304 into final printable data 306, characteristics of the document page 308 described by PDL data 304 may be extracted. Extracted document characteristics 308 may be stored in storage medium 310. Extracted document characteristics 308 may include, for example, the physical size of each page, the total number of pages in a document, paper type, page resolution, page orientation, color printer output, monochrome printer output, cyan toner requirements, magenta toner requirements, yellow toner requirements, black toner requirements, color ink requirements, black ink requirements, and any other page or document characteristic useful in allocating printer resources prior to printing a document. Printer 170 toner and/or ink may be described as a toning material. Similarly, printer 170 toner and/or ink requirements may be described as toning material requirements. Extracted document characteristics 308, may be used to determine printer resource requirements prior to printing the document. Printer resource requirement may include, for example, the amount of paper required to print a document, the sizes of paper required to print a document, and toner/ink levels required to print a document.

In some embodiments, extracted document characteristics 308 may include document characteristics that are not directly described by PDL data 304 and may be determined only after translating PDL data 304 into lower-level and/or final printer data 306. For example, printer toner/ink requirements may not be immediately extracted from PDL data 304, but may be derived from lower-level and/or final printer data 306. Extracted document characteristics 308 stored in storage medium 310 may describe each page in the document, the document as a whole, or a combination thereof.

In other embodiments, document characteristics 308 may be extracted based on multiple types of information that may be provided by lower-level printable data and/or final printable data 306. For example, printer toner/ink requirements may be derived by determining the number of printing dots to be printed on a page using final printable data and deriving the total printer toner/ink requirements based on the standard volume of ink/toner used per printing dot. Similarly, the total toner/ink coverage on a page may be derived by determining the total number of possible printing dots on a page using the size and resolution of the page, and comparing the total number of possible printing dots on a page with the total number of actual dots printed on the page.

In some embodiments, the process shown by FIG. 3 may be repeated for each page in the document described by PDL data 304, until the characteristics 308 for the complete document are stored in storage medium 310. In other embodiments, lower-level printer data may be translated for each page in a document described by PDL data 304, which may then be translated into final printable data 306 describing the complete document.

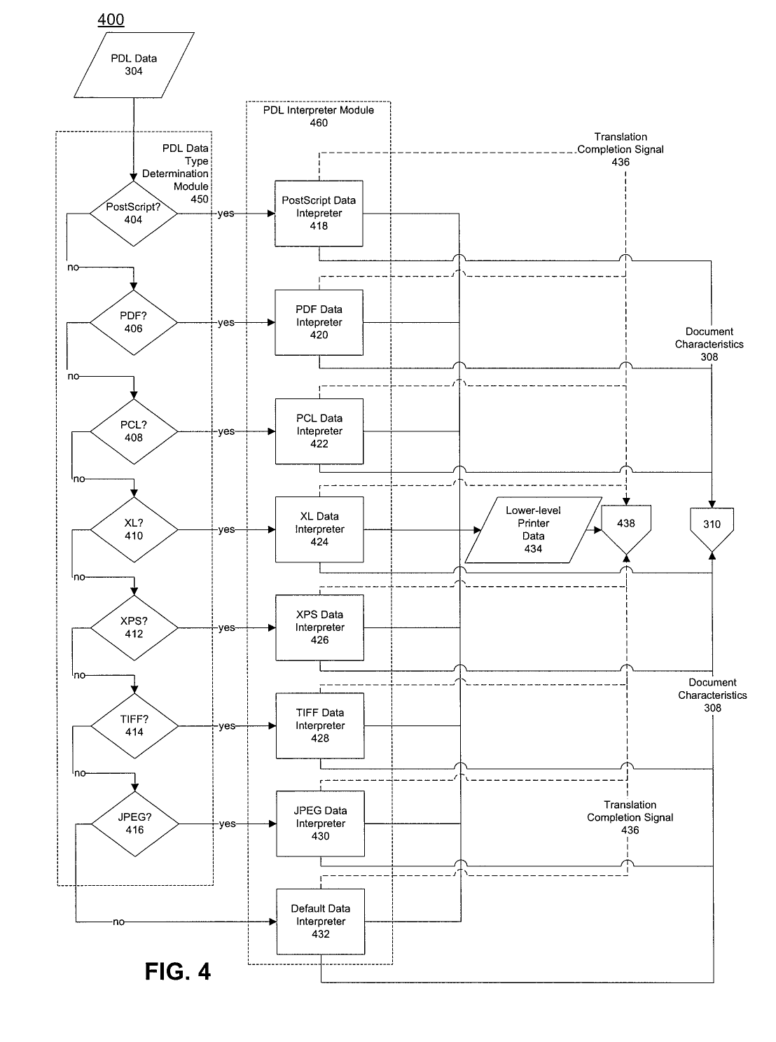

FIG. 4 shows an exemplary flowchart 400 illustrating steps in a method for determining document characteristics when PDL data is being translated into lower-level printer data. A method for determining document characteristics 308 from PDL data 304 may be performed using software, hardware, firmware, or any combination thereof. As illustrated in FIG. 4, method 400 commences by receiving PDL data file 304. In some embodiments, PDL data type determination module 450 may use header information contained in PDL data 304 to determine the PDL data type (e.g., PDF, PCL, XPS) of PDL data 304.

In some embodiments, PDL data determination module 450 may match header information contained in PDL data 304 with known PDL data type patterns to determine the PDL data type of PDL data 304. For example, PDL data type determination module 450 may determine whether PDL data 304 contains PostScript PDL data 404 using header information contained in PDL data type 304. Similarly, PDL data type determination module 450 may determine whether PDL data 304 contains PDF PDL data 406. Further, PDL data type determination module 450 may determine whether PDL data 304 contains PCL PDL data 408. Additionally, PDL data type determination module 450 may determine whether PDL data 304 contains XL PDL data 410. Exemplary PDL data type determination module 450 may determine whether PDL data 304 contains XPS PDL data 412. Similarly, PDL data type determination module 450 may determine whether PDL data 304 contains TIFF PDL data 414. Similarly, PDL data type determination module 450 may determine whether PDL data 304 contains JPEG PDL data 416.

In some embodiments, PDL interpreter module 460 may be invoked to translate PDL data 304 into lower-level printer data 434. PDL interpreter module 460 may be configured to translate PDL data 304 of the PDL file type determined by PDL data type determination module 450. For example, if PDL data type determination module 450 determines that PDL data 304 contains PostScript PDL data, then PDL interpreter module 450 for PostScript data 418 may be invoked. Similarly, if PDL data type determination module 450 determines that PDL data 304 contains PDF PDL data, then PDL interpreter module 450 for PDF data 420 may be invoked. Further, if PDL data type determination module 450 determines that PDL data 304 contains PCL PDL data, then PDL interpreter module 450 for PCL data 422 may be invoked. Additionally, if PDL data type determination module 450 determines that PDL data 304 contains XL PDL data, then PDL interpreter module 450 for XL data 424 may be invoked. If exemplary PDL data type determination module 450 determines that PDL data 304 contains XPS PDL data, then PDL interpreter module 450 for XPS data 426 may be invoked. Similarly, if PDL data type determination module 450 determines that PDL data 304 contains TIFF PDL data, then PDL interpreter module 450 for TIFF data 428 may be invoked. Similarly, if PDL data type determination module 450 determines that PDL data 304 contains JPEG PDL data, then PDL interpreter module 450 for JPEG data 430 may be invoked. If PDL data type determination module 450 is unable to determine the PDL data type of PDL data 304, PDL interpreter module 460 may be configured to a default setting 432.

In some embodiments, lower-level printer data 434 may be described by low-level instructions called primitives. In some embodiments, lower-level printer data 434 may comprise display lists.

Once lower-level printer data 434 has been generated by PDL interpreter module 460, translation completion signal 436 may be generated to indicate that translation to lower-level printer data 434 for a page is complete. This translation completion signal 436 may be used to initiate further translation of lower-level printer data 434 into final printable data 306.

During the process of translating PDL data 304 into lower-level printer data 434, characteristics of the document page 308 described by PDL data 304 may be extracted. In some embodiments, extracted document characteristics 308 include document characteristics that are not directly described by PDL data 304 and may be determined only after translating PDL data 304 into lower-level printer data 434.

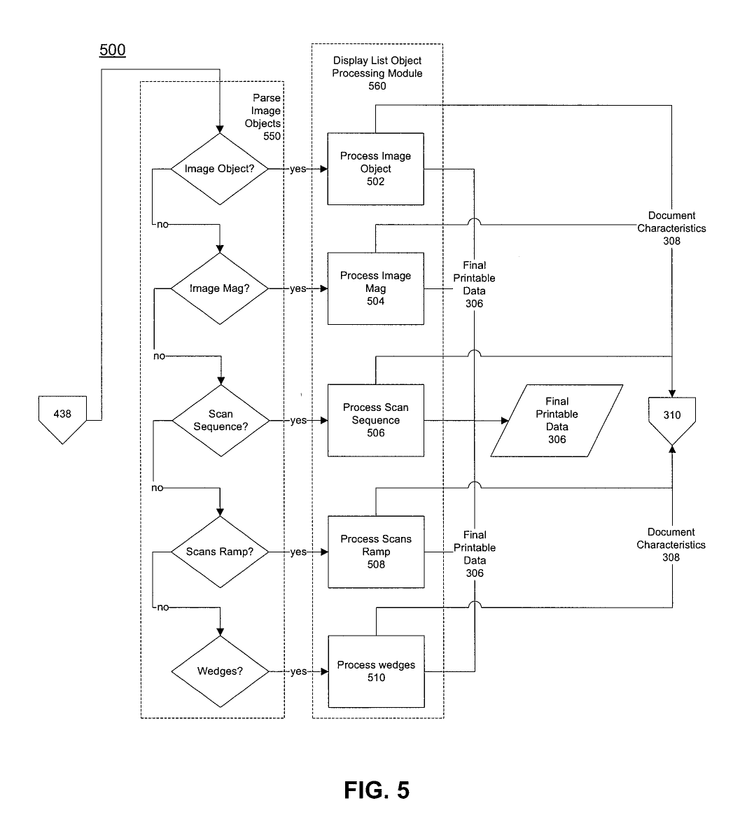

FIG. 5 shows an exemplary flowchart 500 illustrating steps in a method for determining document characteristics when lower-level printer data is being translated into final printable data. The method shown in FIG. 5 may be performed using software, hardware, firmware, or any combination thereof. The process commences by receiving lower-level printer data 434 translated from PDL data 304 by PDL interpreter module 460. In some embodiments, lower-level printer data 434 may comprise display lists of objects. Display lists objects may include text, graphics, and image data objects.

In some embodiments, lower-level printer data 434 may be translated into final printable data 306. Parse image objects module 550 may parse lower-level printer data 434, which may comprise display list objects to extract the different types of display list objects contained in lower-level printer data 434. Parsed display list objects may be translated into final printable data 306 using display list object processing module 560. Display list object processing module 560 may be configured to process a specific display list object type. For example, lower-level printer data 434 that includes image data objects may be processed by display list object processing module 560 into final printable data 306. Similarly, lower-level printer data 434 that includes image mag data objects may be processed by display list object processing module 560 into final printable data 306. Further, lower-level printer data 434 that includes scan sequence data objects may be processed by display list object processing module 560 into final printable data 306. In addition, lower-level printer data 434 that includes scan ramp data objects may be processed by display list object processing module 560 into final printable data 306. Similarly, lower-level printer data 434 that includes wedge data objects may be processed by image object processing module 560 into final printable data 306.

In some embodiments, final printable data 306 may be described by bitmap data. Final printable data 306 may be used by printer 170 to print the document described by PDL data 304.

During the process of translating lower-level printer data 434 into final printable data 306, characteristics of the document page 308 described by PDL data 304 are extracted. In some embodiments, extracted document characteristics 308 include document characteristics that are not directly described by PDL data 304 or lower-level printer data 434 and may be determined only after translating PDL data 304 into final printable data 306.

In some embodiments, document characteristics 308 extracted from translation of PDL data 304 into lower-level printer data 434 and translation of lower-level printer data 434 into final printable data 306, or obtained from original PDL data file 304, may be formatted and stored in a storage medium 310. Also the original PDL data file 304 may be stored in the storage medium in association with the extracted document characteristics 308 thereof. Extracted document characteristics 308 may include, for example, the physical size of each page, the total number of pages, paper type, page resolution, page orientation, color printer output, monochrome printer output, cyan toner requirements, magenta toner requirements, yellow toner requirements, black toner requirements, color ink requirements, black ink requirements, and any other page or document characteristics useful in allocating printer resources prior to printing a document. In some embodiments, extracted document characteristics 308 may be formatted in comma separated format. In some embodiments, extracted document characteristics 308 may be formatted in a manner that proves useful in displaying the document characteristics 308. Stored document characteristics 310 may provide information regarding each page in a document, a document as a whole, or a combination thereof.

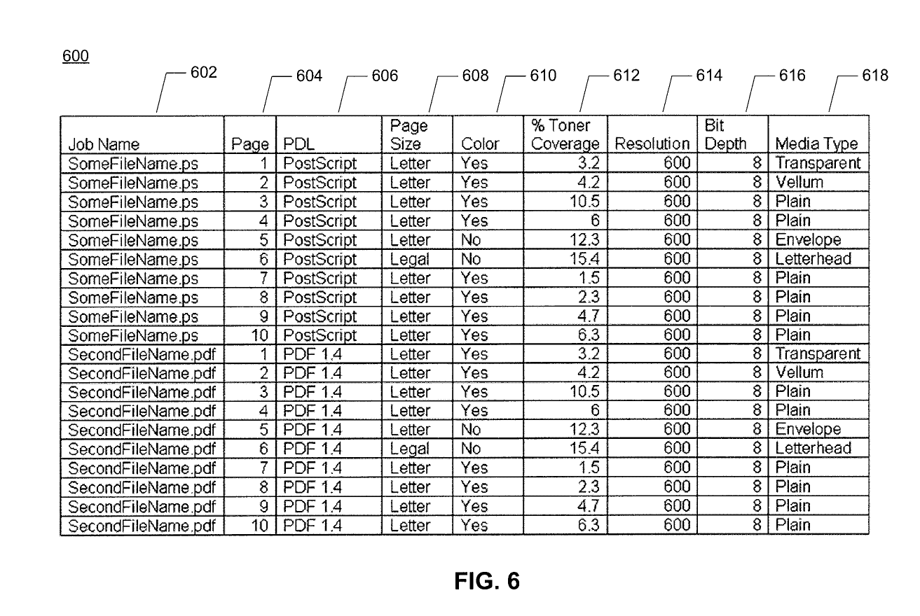

FIG. 6 shows an exemplary graphical table format 600 for displaying document characteristics. The display format shown is exemplary and for illustration purposes only and other display format including graphical display formats, or GUI based formats, and user-interactive formats may be used to display document characteristics, Graphical table format 600 for displaying document characteristics 308 may be displayed using exemplary computing device 110. In some embodiments, graphical table format 600 may be displayed on a page printed by printer 170. Graphical table format 600 allows a user to quickly determine the characteristics of a document 308 and allocate printer resources prior to printing the document. In some embodiments, other graphical display format 600 may be used and include one or more of bar graphs, line graphs, pie charts, column graphs, and any other visual representation that allows a user to quickly determine the characteristics of a document.

Graphical table format 600 may display the PDL data file name 602 of PDL data 304, which is stored in the memory 172 or the secondary storage 173, using extracted document characteristics. In addition, as shown in FIG. 6, graphical display format 600 may also display page number 604 and PDL data file type 606, which may be derived from extracted document characteristics 308. Further Graphical table format 600 may also display page size 608 and whether the document identified in column 602 is printed in color 610. Similarly, toner requirements 612 for printer 170, page resolution 614, bit depth 616, and required paper type 618 may also be displayed. Bit depth 616 may describe the number of bits used to represent the color and/or grayscale levels of a single printed pixel in the document.

Additional document characteristics that may be displayed graphically in table format 600 may include, for example, the total number of pages in a document, page orientation, cyan toner requirements, magenta toner requirements, yellow toner requirements, black toner requirements, color ink requirements, black ink requirements, and any other information useful in allocating printer resources prior to printing a document. Displayed document characteristics may provide information regarding each page in a document, a document as a whole, or a combination thereof. In some embodiments, graphical table format may be customizable and a user may be able to specify the types of data and preferred display format to view the information requested.

In some embodiments, a program for conducting the above processes can be recorded on computer-readable media 150 or computer-readable memory. These include, but are not limited to, Read Only Memory (ROM), Programmable Read Only Memory (PROM), Flash Memory, Non-Volatile Random Access Memory (NVRAM), or digital memory cards such as secure digital (SD) memory cards, Compact Flash™, Smart Media™, Memory Stick™, and the like. In some embodiments, one or more types of computer-readable media may be coupled to printer 170. In certain embodiments, portions of a program to implement the systems, methods, and structures disclosed by be delivered over network 140.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for determining document characteristics from a file containing PDL data, the method comprising:
determining a type of PDL data contained in the file;
translating the PDL data for the PDL data type into a final printable data;
extracting document characteristics using information obtained during the translation of the PDL data into the final printable data; and
storing the extracted document characteristics.

2. The method of claim 1, wherein the extracted document characteristics include document characteristics relating to printer resource requirements derived from the PDL data.

3. The method of claim 1, wherein the extracted document characteristics include at least one of:
PDL file type information;
the number of pages in the document;
a size of the document;
a resolution of the document;
an orientation of the document;
a color output of the document;
a bit depth of pages in the document;
a paper type of pages in the document; or
toning material requirements.

4. The method of claim 1, wherein the determination of the type of PDL data contained in the file is based on information contained in the PDL file header.

5. The method of claim 1, wherein the final printable data is in a bitmap format.

6. The method of claim 1, wherein the method further comprises displaying the document characteristics in a graphical format.

7. The method of claim 1, wherein the method is performed on one or more of:
a computer; and
a printing device.

8. The method of claim 3, wherein the toning material requirements are extracted by determining the number of dots to be printed the page described by the PDL data and determining the total volume of toning material required to print the page based on the average volume toning material required to print a single printed dot.

9. A computer-readable medium that stores instructions, which when executed by a processor perform steps in a method for determining document characteristics from a file containing PDL data, the steps comprising:
determining a type of PDL data contained in the file;
translating the PDL data for the PDL data type into a final printable data;
extracting document characteristics using information obtained during the translation of the PDL data into the final printable data; and
storing the extracted document characteristics.

10. The method of claim 9, wherein the extracted document characteristics include document characteristics relating to printer resource requirements derived from the PDL data.

11. The method of claim 9, wherein the extracted document characteristics include at least one of:
PDL file type information;
the number of pages in the document;
a size of the document;
a resolution of the document;
an orientation of the document;
a color output of the document;
a bit depth of pages in the document;
a paper type of pages in the document; or
toning material requirements.

12. The method of claim 9, wherein the determination of the type of PDL data contained in the file is based on information contained in the PDL file header.

13. The method of claim 9, wherein the final printable data is in a bitmap format.

14. The method of claim 9, wherein the method further includes the step of displaying the document characteristics in a graphical format.

15. A computer-readable medium containing instructions for controlling a computer system to perform steps in a method for determining document characteristics from a file containing PDL data, the method comprising:
determining a type of PDL data contained in the file;
translating the PDL data for the PDL data type into a final printable data;
extracting document characteristics using information obtained during the translation of the PDL data into the final printable data; and
storing the extracted document characteristics.

16. The computer-readable medium of claim 15, wherein the extracted document characteristics include document characteristics relating to printer resource requirements derived from the PDL data.

17. The computer-readable medium of claim 15, wherein the extracted document characteristics include at least one of:
PDL file type information;
the number of pages in the document;
a size of the document;
a resolution of the document;
an orientation of the document;
a color output of the document;
a bit depth of pages in the document;
a paper type of pages in the document; or
toning material requirements.

18. The computer-readable medium of claim 15, wherein the determination of the type of PDL data contained in the file is based on information contained in the PDL file header.

19. The computer-readable medium of claim 15, wherein the final printable data is in a bitmap format.

20. The computer-readable medium of claim 15, wherein the method further includes the step of displaying the document characteristics in a graphical format.
